(19) United States
(12) Patent Application Publication
(10) Pub. No.: US 2022/0245947 A1
(43) Pub. Date: Aug. 4, 2022

(54) CONGESTION DEGREE ESTIMATION DEVICE, CONGESTION DEGREE ESTIMATION METHOD, AND COMPUTER READABLE MEDIUM

(71) Applicant: Mitsubishi Electric Corporation, Tokyo (JP)

(72) Inventors: Ryoji HATTORI, Tokyo (JP); Seiji OKUMURA, Tokyo (JP); Junya MIYAGI, Tokyo (JP); Akito ARAI, Tokyo (JP); Takahisa ENOMOTO, Tokyo (JP)

(73) Assignee: Mitsubishi Electric Corporation, Tokyo (JP)

(21) Appl. No.: 17/725,001

(22) Filed: Apr. 20, 2022

Related U.S. Application Data
(63) Continuation of application No. PCT/JP2019/048664, filed on Dec. 12, 2019.

(51) Int. Cl. G06V 20/52; G06V 20/54; G06K 9/62

(52) U.S. Cl. CPC G06V 20/53; G06K 9/623; G06V 20/54

(57) ABSTRACT

A first estimation unit (23) estimates, on the basis of sensor data acquired from a sensor (42) allocated to a first position in a target space, a first congestion degree being a congestion degree about the first position. A second estimation unit (26) estimates a second congestion degree being a congestion degree about a second position, on the basis of the first congestion degree, the second position being a position on a travel route of a traveling object in the target space and being different from the first position. A third estimation unit (27) estimates a third congestion degree being a congestion degree about a third position which is neither the first position nor the second position in the target space, on the basis of the first congestion degree and the second congestion degree.

### CROSS REFERENCE TO RELATED APPLICATIONS

This application is a Continuation of PCT International Application No. PCT/JP2019/048664, filed on Dec. 12, 2019, which is hereby expressly incorporated by reference into the present application.

### TECHNICAL FIELD

The present invention relates to a technique of estimating a congestion degree in a target space.

### BACKGROUND ART

In spaces where congestion occurs due to people or vehicles, namely, in large-scale facilities such as stations, airports, and commercial facilities, and in urban blocks in city areas, it is required to measure a congestion degree quantitatively or qualitatively.

Excessive congestion impairs comfort and economy, and causes crowd accidents. Therefore, it is important to eliminate congestion or to control an occurrence of congestion by taking measures such as appropriate guidance and crowd management. In order to take the above-mentioned measures, congestion degree measurement is necessary.

As a method of measuring a congestion degree, there is a technique of analyzing sensor data obtained by a sensor such as a surveillance camera, an infrared sensor, and a laser sensor, thereby measuring a congestion degree within a sensing range of the sensor. When congestion degree measurement conventionally dependent on visual observation and subjective judgment by a security personnel is automated on the basis of the sensor data, an accuracy and stability of the measurement can be improved, and continuous measurement over time can be performed.

When measuring the congestion degree in a space such as a large-scale facility or an urban block, a means for presenting a measurement result to a user is also important. The user is a guard, a security officer, or an ordinary person who is visiting the space. Congestion is present in a space with a varied density distribution. Therefore, it is desirable that the distribution of the congestion degree is presented in a form that is easy to grasp intuitively by, for example, displaying the distribution through superposing on a map of a target space in a heat map format.

Patent Literature 1 describes a technique of measuring a congestion degree within an angle of view of a camera by analyzing an image captured by a surveillance camera. A method that uses a surveillance camera as a sensor for measuring the congestion degree is effective in a place where a large number of surveillance cameras are installed, because existing surveillance camera equipment can be utilized. On the other hand, the method that uses a sensor such as a surveillance camera can measure only a congestion degree within a detection range of the sensor.

As described above, it is desirable that the congestion degree is presented by, for example, displaying the congestion degree through superposing on a map of the target space in a heat map format. However, by measuring only the detection range of the sensor, the congestion degree can be displayed only about a position on the map where the sensor is installed. That is, the distribution of the congestion degree cannot be presented in a form that is easy to grasp intuitively.

It may be possible to estimate a congestion degree of a position where a sensor is not installed from congestion degree data obtained at a position where a sensor is installed. Patent Literature 2 describes a technique of estimation by spatially interpolating data of a non-observed point by using data of some observed points.

### CITATION LIST

### Patent Literature

Patent Literature 1: JP 2019-505568 A

Patent Literature 2: JP 2009-291047 A

### SUMMARY OF INVENTION

### Technical Problem

With the technique described in Patent Literature 2, interpolation is performed uniformly in all directions. A congestion degree propagates to a surrounding as a crowd travels. Therefore, an influence range of observation point data is affected by a traveling direction along a passage and by division of a space by walls. Accordingly, an interpolation result that reflects the reality cannot be obtained from interpolation that is uniform in all directions.

An objective of the present invention is to enable appropriate estimation of a congestion degree in a target space.

### Solution to Problem

A congestion degree estimation device according to the present invention includes:

a first estimation unit to estimate, on a basis of sensor data acquired from a sensor allocated to a first position in a target space, a first congestion degree being a congestion degree about the first position;

a second estimation unit to estimate a second congestion degree being a congestion degree about a second position, on a basis of the first congestion degree estimated by the first estimation unit, the second position being a position on a travel route of a traveling object in the target space and being different from the first position; and

a third estimation unit to estimate a third congestion degree being a congestion degree about a third position which is neither the first position nor the second position in the target space, on a basis of the first congestion degree and the second congestion degree which is estimated by the second estimation unit.

### Advantageous Effects of Invention

In the present invention, a second congestion degree about a position on a travel route of a traveling object is estimated from a first congestion degree estimated on the basis of sensor data. Then, from the first congestion degree and the second congestion degree, a third congestion degree about another position is estimated. This makes it possible to appropriately estimate a congestion degree in a target space.

### BRIEF DESCRIPTION OF DRAWINGS

FIG. 1 is a configuration diagram of a congestion degree estimation device 10 according to Embodiment 1.

FIG. 2 is a plan view of a target space 50 according to Embodiment 1.

FIG. 3 is a flowchart indicating overall operations of the congestion degree estimation device 10 according to Embodiment 1.

FIG. 4 is a flowchart of a congestion degree estimation process according to Embodiment 1.

FIG. 5 is a diagram illustrating an example of a mask image 32 according to Embodiment 1.

FIG. 6 is a diagram illustrating an example of a graph 33 according to Embodiment 1.

FIG. 7 is a flowchart of a second estimation process according to Embodiment 1.

FIG. 8 is an explanatory diagram of a distance calculation process according to Embodiment 1.

FIG. 9 is an explanatory diagram of the distance calculation process according to Embodiment 1.

FIG. 10 is a flowchart of a third estimation process according to Embodiment 1.

FIG. 11 is a configuration diagram of a congestion degree estimation device 10 according to Modification 2.

### DESCRIPTION OF EMBODIMENTS

### Embodiment 1

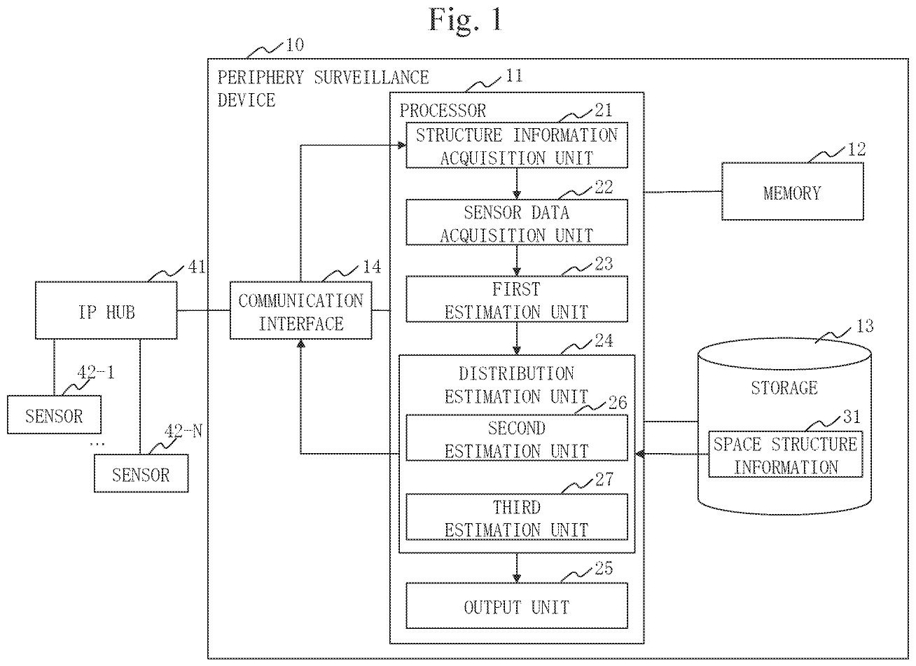

A configuration of a congestion degree estimation device 10 according to Embodiment 1 will be described with referring to FIG. 1.

The congestion degree estimation device 10 is a computer.

The congestion degree estimation device 10 is provided with hardware devices which are a processor 11, a memory 12, a storage 13, and a communication interface 14. The processor 11 is connected to the other hardware devices via a signal line and controls the other hardware devices.

The processor 11 is an Integrated Circuit (IC) which performs processing. Specific examples of the processor 11 are a Central Processing Unit (CPU), a Digital Signal Processor (DSP), and a Graphics Processing Unit (GPU).

The memory 12 is a storage device which stores data temporarily. Specific examples of the memory 12 are a Static Random-Access Memory (SRAM) and a Dynamic Random-Access Memory (DRAM).

The storage 13 is a storage device which keeps data. A specific example of the storage 13 is a Hard Disk Drive (HDD). Alternatively, the storage 13 may be a portable recording medium such as a Secure Digital (SD, registered trademark) memory card, a CompactFlash (registered trademark, CF), a NAND flash, a flexible disk, an optical disk, a compact disk, a Blu-ray (registered trademark) Disc, and a Digital Versatile Disk (DVD).

The communication interface 14 is an interface to communicate with an external device. Specific examples of the communication interface 14 are an Ethernet (registered trademark) port, a Universal Serial Bus (USB) port, and a High-Definition Multimedia Interface (HDMI, registered trademark) port.

The congestion degree estimation device 10 is provided with a structure information acquisition unit 21, a sensor data acquisition unit 22, a first estimation unit 23, a distribution estimation unit 24, and an output unit 25, as function constituent elements. The distribution estimation unit 24 is provided with a second estimation unit 26 and a third estimation unit 27 as function constituent elements. Functions of the function constituent elements of the congestion degree estimation device 10 are implemented by software.

A program that implements the functions of the function constituent elements of the congestion degree estimation device 10 is stored in the storage 13. This program is read into the memory 12 by the processor 11 and run by the processor 11. The functions of the function constituent elements of the congestion degree estimation device 10 are thus implemented.

Space structure information 31 is stored in the storage 13.

FIG. 1 illustrates the processor 11 only one. However, there may be a plurality of processors 11. The plurality of processors 11 may cooperate with each other to run the program that implements the functions.

The congestion degree estimation device 10 is connected to an Internet Protocol (IP) hub 41 via the communication interface 14. The IP hub 41 is connected to a plurality of sensors 42. In FIG. 1, the IP hub 41 is connected to N of sensors 42 consisting of sensors 42-1 to 42-N.

The IP hub 41 is a device that receives sensor data outputted from each sensor 42 and delivers the received sensor data to the congestion degree estimation device 10.

In FIG. 1, the IP hub 41 is provided outside the congestion degree estimation device 10. Alternatively, the congestion degree estimation device 10 may be provided with the IP hub 41. There is a case where each sensor 42 is connected to the Internet with using a public line of telecommunication and outputs sensor data to the Internet. In this case, the Internet may be regarded as the IP hub 41, and the congestion degree estimation device 10 may receive the sensor data via the Internet. If a method by which the sensor 42 outputs data is a protocol other than IP, the IP hub 41 is an aggregation device that matches that protocol.

Each sensor 42 is a device that acquires sensor data that can be utilized for measuring a congestion degree and outputs the sensor data by wired or wireless communication.

Each sensor 42 may be any sensor as far as it has a function of acquiring sensor data that can be utilized for measuring the congestion degree and outputting the sensor data via a network by wired or wireless communication. A specific example of each sensor 42 is a surveillance camera, an infrared sensor, a laser sensor, an ultrasonic sensor, or a sound collection microphone. The sensor 42 may be a counting system incorporating a beacon to generate a particular signal, a device capable of counting a number of portable terminals that are near the beacon, and the portable terminals.

***Description of Operations***

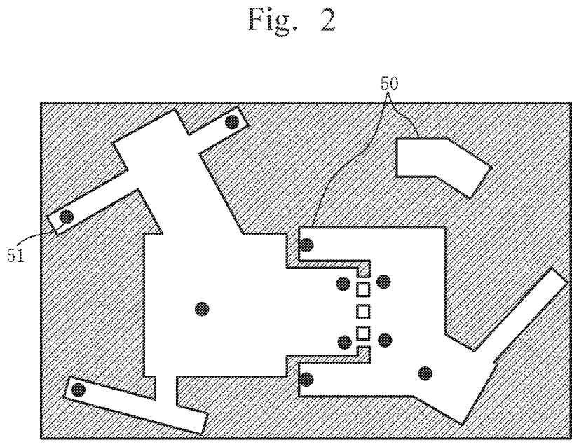

Operations of the congestion degree estimation device 10 according to Embodiment 1 will be described with referring to FIGS. 2 to 10.

An operation procedure of the congestion degree estimation device 10 according to Embodiment 1 corresponds to a congestion degree estimation method according to Embodiment 1. A program that implements the operations of the congestion degree estimation device 10 according to Embodiment 1 corresponds to a congestion degree estimation program according to Embodiment 1.

A target space 50 whose congestion degree is to be estimated in Embodiment 1 will be described with referring to FIG. 2.

The target space 50 is a space where a range a traveling object can travel is limited. Specifically, the target space 50 is a space constituted of passages and open spaces partitioned by a wall and so on. Alternatively, the target space 50 may be a space constituted only of open spaces and where a traveling object can travel freely. Specific examples of the traveling object are a person, a vehicle, and so on. In Embodiment 1, the traveling object is a person.

Measurement points 51 (black points in FIG. 2) are arranged in the target space 50 discretely and in a non-lattice manner. It is only about the measurement points 51 that sensor data concerning the congestion degree can be acquired from the sensors 42.

In Embodiment 1, one sensor 42 is provided to correspond to one measurement point 51. Alternatively, a plurality of sensors 42 may be provided to correspond to one measurement point, or one sensor 42 may be provided to correspond to a plurality of measurement points. In Embodiment 1, all sensors 42 are fixed-type sensors that are fixed at installing locations. Alternatively, the sensors 42 may be movable-type sensors that can move.

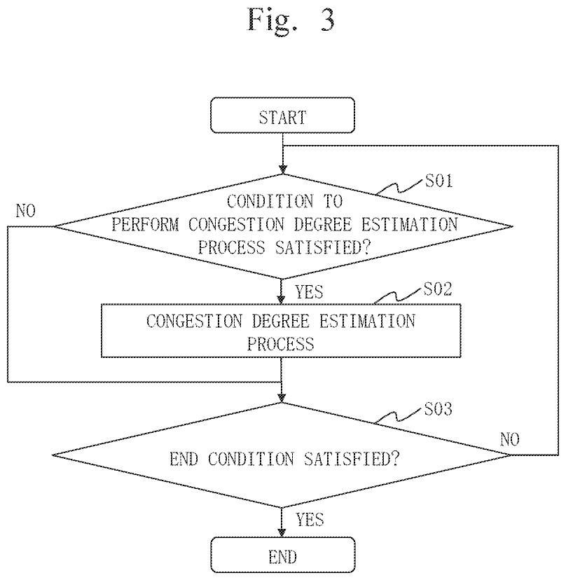

Overall operations of the congestion degree estimation device 10 according to Embodiment 1 will be described with referring to FIG. 3.

When the congestion degree estimation device 10 is started, it waits until a condition to execute a congestion degree estimation process is satisfied (step S01). The condition to perform the congestion degree estimation process may be, for example: a predetermined period of time elapses after starting, or after the last congestion degree estimation process is performed; a predetermined time point has arrived; or a signal instructing execution of the congestion degree estimation process is received from outside the device. The condition to perform the congestion degree estimation process may be a combination of a plurality of such conditions, or may be a condition other than them.

When the condition to execute the congestion degree estimation process is satisfied, then, the congestion degree estimation device 10 executes the congestion degree estimation process (step S02). The congestion degree estimation process is a process of estimating a congestion degree on the basis of the sensor data received from the sensor 42 and outputting the estimated congestion degree. Details of the congestion degree estimation process will be described later.

When the congestion degree estimation process is ended, the congestion degree estimation device 10 judges whether an end condition is satisfied or not (step S03). If the end condition is satisfied, the congestion degree estimation device 10 stops operation. If the end condition is not satisfied, the congestion degree estimation device 10 is set in a state of waiting for execution of a congestion degree estimation process again. The end condition may be, for example: a signal instructing an end is received from outside the device; or a predetermined time point has arrived. The end condition may be a combination of a plurality of such conditions, or may be a condition other than them.

To summarize, after the congestion degree estimation device 10 is started, the congestion degree estimation device 10 continues an operation of outputting a congestion degree estimation result at a predetermined time interval, or each time a predetermined condition is satisfied. The congestion degree estimation device 10 performs an ending operation when a predetermined condition is satisfied.

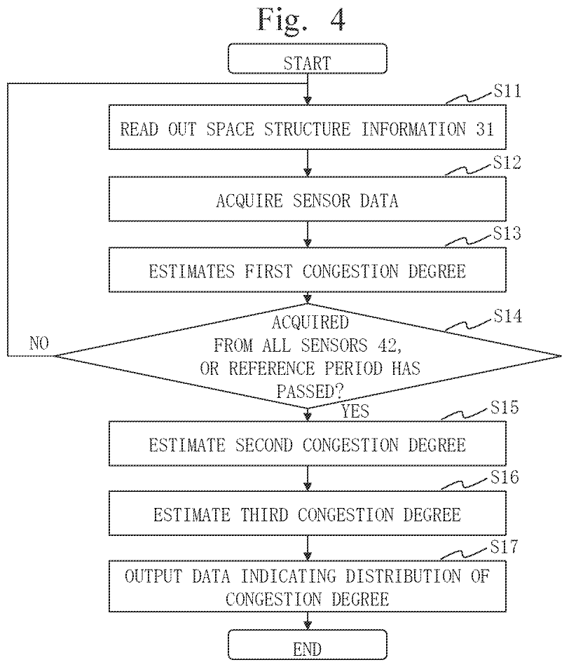

Detailed operations of the congestion degree estimation process (step S02 of FIG. 3) will be described with referring to FIG. 4.

(Step S11 of FIG. 4: Structure Information Acquisition Process)

The structure information acquisition unit 21 reads out the space structure information 31 from the storage 13. The structure information acquisition unit 21 outputs the readout space structure information 31 to the distribution estimation unit 24.

In Embodiment 1, the space structure information 31 is created in advance and is stored in the storage 13. Alternatively, the space structure information 31 may be outputted from the outside when step S11 is executed. The space structure information 31 may be created from source information by the structure information acquisition unit 21 when step S11 is executed.

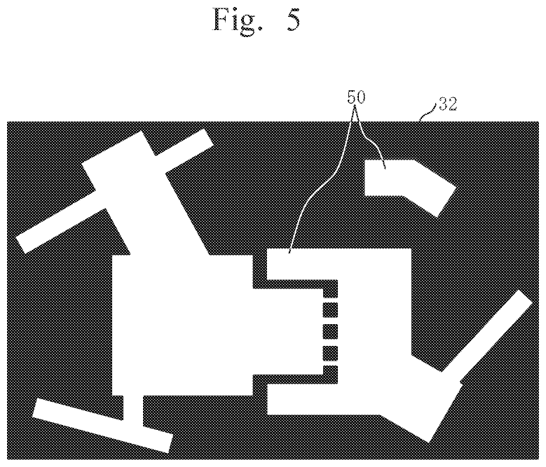

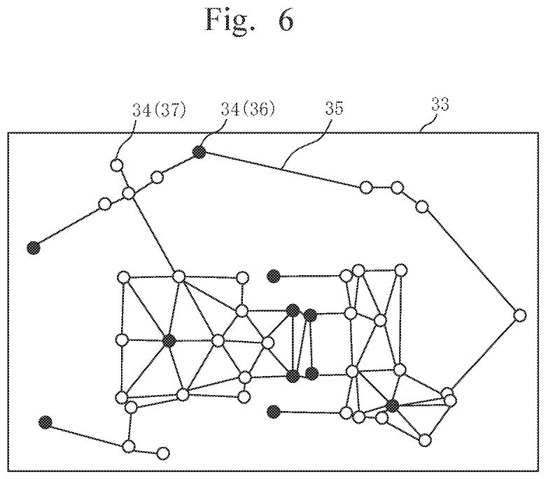

The space structure information 31 according to Embodiment 1 will be described with referring to FIGS. 5 and 6.

FIGS. 5 and 6 illustrate the space structure information 31 corresponding to the target space 50 illustrated in FIG. 2.

The space structure information 31 is information indicating a shape of the target space 50, positions of the measurement points 51, and connecting relationships among regions constituting the target space 50. In Embodiment 1, the space structure information 31 is provided with a mask image 32 and a graph 33. The shape of the target space 50 is expressed by the mask image 32. The positions of the measurement points 51 are expressed by the graph 33. The connecting relationships among the regions constituting the target space 50 are expressed by the mask image 32 and the graph 33.

As illustrated in FIG. 5, the mask image 32 is image data expressing the target space 50. Coordinates in the mask image 32 correspond to two-dimensional coordinates in the target space 50. In FIG. 5, regions expressed in white are the target space 50, and regions expressed in black are regions that are not the target space 50. Connected regions expressed in white indicate that they are connected spatially.

As illustrated in FIG. 6, the graph 33 is formed of nodes 34 and edges 35 which connect the nodes 34. The nodes 34 are provided at first positions which are the measurement points 51 to which the sensors 42 are allocated, and at second positions which are positions on a travel route of the traveling object in the target space 50 and are different from the first positions. Among positions on the travel route of the traveling object those positions whose spatial connecting relationships in the target space 50 can be appropriately expressed by the graph 33 are set as the second positions. For example, if a passage exists in the target space 50, the second positions are set such that the edges 35 are set along a central portion of the passage.

Nodes 34 expressing the first positions will be referred to as data nodes 36 (nodes 34 expressed by black points in FIG. 6). Nodes 34 expressing the second positions will be referred to as interpolation nodes 37 (nodes 34 expressed by white points in FIG. 6). A sensor Identifier (ID), being an identifier of a sensor 42 associated with a first position expressed by a data node 36, is allotted to that data node 36.

For a node 34, coordinates in the target space 50 which are on the same coordinate system as the space structure information 31 are defined. Therefore, when the graph 33 is lapped over the mask image 32, the node 34 is always present in a region expressed in white in FIG. 5. A length of an edge 35 connecting nodes 34 corresponds to a distance between the nodes 34 in the target space 50. For example, the second positions are set such that the edges 35 are set along the central portion of the passage. Therefore, a length of an edge 35 between nodes 34 at two ends of the passage expresses a distance taken along the passage.

An edge in the graph 33 is provided between nodes between which the traveling object can travel. Therefore, the presence of the edge expresses that regions where the nodes at the two ends of the edge exist are spatially connected to each other.

The connecting relationships among the regions constituting the target space 50 are expressed not only by the graph 33 but also by the mask image 32. However, there is a connecting relationship that cannot be expressed by the mask image 32 exceptionally.

For example, in FIG. 2, a region X is a first floor, and a region Y is a second floor. That is, the region X and the region Y are not adjacent regions. For this reason, in the mask image 32 illustrated in FIG. 5, the region X and the region Y are seemingly not connected to each other. However, in the graph 33 illustrated in FIG. 6, it is possible to travel between the region X and the region Y using a means such as an elevator. Therefore, a node 34 in the region X and a node 34 in the region Y are connected to each other via an edge 35. This expresses that the region X and the region Y are spatially connected to each other.

Inversely, there is a connecting relationship that cannot be expressed by the graph 33 exceptionally.

For example, near an area Z in FIG. 2, a plurality of passage-like regions exist, and a region that is not the target space 50 exists between the passage-like regions. In such a place, sometimes the nodes 34 are not set finely. As illustrated in FIG. 6, in the graph 33, sometimes an edge 35 is set across a region that is not the target space 50. As a result, in the graph 33, it seems as if a region that is not the target space 50 did not exist. However, the mask image 32 illustrated in FIG. 5 expresses that a region that is not the target space 50 exists between passage-like regions.

The mask image 32 is given in the form of an image file in a format such as a bit map (BMP) format, a Portable Network Graphics (PNG) format, and a Joint Photographic Experts Group (JPEG) format.

The graph 33 is given in the form of a structured text file in a format such as an eXtensible Markup Language (XML) format, a JavaScript Object Notation (JSON) format, and a Comma-Separated Values (CSV) format.

A process of step S11 corresponds to an initialization process of the congestion degree estimation device 10. Therefore, the process of step S1 may be executed only at initial start-up of the congestion degree estimation device 10 and at a time of setting change of the congestion degree estimation device 10.

(Step S12 of FIG. 4: Sensor Data Acquisition Process)

The sensor data acquisition unit 22 acquires the sensor data outputted from each sensor 42 via the IP hub 41.

Specifically, when the sensor data is transmitted from the IP hub 41, the sensor data acquisition unit 22 acquires the sensor data. The sensor data acquisition unit 22 outputs the acquired sensor data, along with the sensor ID of the sensor 42 being a sensor data output source, to the first estimation unit 23.

The sensor ID of the sensor 42 being the sensor data output source is identified by Method 1 or Method 2.

(Method 1)

The sensor data acquisition unit 22 holds in advance a table on which the sensors ID and addresses of the sensors 42 in the network are associated with each other. The sensor data acquisition unit 22 acquires, along with the sensor data, an address of an output source of the sensor data. The sensor data acquisition unit 22 looks up the table and identifies a sensor ID corresponding to the acquired address.

(Method 2)

The sensor 42 outputs, along with sensor data, additional information that can identify the sensor ID. The sensor data acquisition unit 22 acquires, along with the sensor data, the additional information that can identify the sensor ID. The sensor data acquisition unit 22 identifies the sensor ID from the additional information.

A specific example of the additional information is Global Navigation Satellite System (GNSS) information indicating the position of the sensor 42. When the sensor data acquisition unit 22 acquires the GNSS information as the additional information, the sensor data acquisition unit 22 compares positions of the measurement points 51 in the space structure information 31 with positions indicated by the GNSS information, so as to identify a data node 36 corresponding to the GNSS information. Then, the sensor data acquisition unit 22 identifies a sensor ID of a sensor 42 corresponding to the identified data node 36.

(Step S13 of FIG. 4: First Estimation Process)

The first estimation unit 23 estimates a first congestion degree being a congestion degree about the first position on the basis of the sensor data acquired in step S12.

Specifically, the first estimation unit 23 identifies the first position which is a measurement point 51 corresponding to the sensor ID acquired in step S12. The first estimation unit 23 estimates the first congestion degree about the identified first position on the basis of the sensor data. The first estimation unit 23 outputs the identified first congestion degree, along with the sensor ID, to the distribution estimation unit 24.

The first congestion degree may be estimated from the sensor data by any method.

For example, assume that the sensor 42 is a surveillance camera. In this case, the first estimation unit 23 compares background image data registered in advance, with image data which is sensor data, and extracts a foreground portion. Then, the first estimation unit 23 estimates a number of persons from an area of the foreground portion, thereby estimating the first congestion degree. Alternatively, the first estimation unit 23 detects a person from the image data which is sensor data, with using machine learning. Then, the first estimation unit 23 counts the number of detected persons, thereby estimating the first congestion degree.

For example, assume that the sensor 42 is a range sensor such as a laser sensor. In this case, the first estimation unit 23 detects a person from a shape of an object within a sensing range obtained by integrating in terms of time and space, range data which is sensor data. Then, the first estimation unit 23 counts a number of detected persons, thereby estimating the first congestion degree.

When estimating the first congestion degree, sometimes parameters which are adjusted in advance are required in addition to the sensor data. A specific example of the parameters adjusted in advance are the background image data mentioned above. In this case, the first estimation unit 23 may save the parameters adjusted in advance in the storage 13, such that the parameters are associated with sensors ID, and may identify a corresponding parameter which is adjusted in advance, from the sensor ID acquired in step S12.

(Step S14 of FIG. 4: Control Process)

If, in step S12, the sensor data is acquired from all the sensors 42 installed in the target space 50, or a reference time has passed, the first estimation unit 23 proceeds to a process of step S15. On the other hand, if neither applies, the first estimation unit 23 returns to the process of step S12.

(Step S15 of FIG. 4: Second Estimation Process)

The second estimation unit 26 of the distribution estimation unit 24 estimates a congestion degree about a second position, as a second congestion degree, on the basis of the first congestion degree about each first position estimated in step S13, the second position being a position on a travel route of a traveling object in the target space 50 and being a position different from the first position. The second estimation unit 26 outputs the first congestion degree about each first position and the second congestion degree about each second position to the third estimation unit 27.

Specifically, the second estimation unit 26 focuses on each interpolation node 37 as a target, and calculates a distance on the graph 33 from the interpolation node 37 to each data node 36. Then, the second estimation unit 26 focuses on each interpolation node 37 as a target, and estimates a second congestion degree about the second position expressed by the target interpolation node 37, from the distance from the target interpolation node 37 to each data node 36, and from the first congestion degree about the first position expressed by each data node 36.

(Step S16 of FIG. 4: Third Estimation Process)

The third estimation unit 27 of the distribution estimation unit 24 estimates a third congestion degree being a congestion degree about a third position which is neither the first position nor the second position in the target space 50, on the basis of the first congestion degree about each first position estimated in step S13 and the second congestion degree about each second position estimated in step S15. The third estimation unit 27 outputs the first congestion degree about each first position, the second congestion degree about each second position, and the third congestion degree about each third position, to the output unit 25.

Specifically, first, the third estimation unit 27 focuses on each edge 35 of the graph 33 as a target and, concerning an on-edge position which is a third position located on the target edge 35, calculates distances from nodes 34 on two ends of the target edge to the on-edge position. Then, the third estimation unit 27 estimates a third congestion degree about the on-edge position, from the distances from the nodes 34 on the two ends to the on-edge position, and from congestion degrees about the positions expressed by the nodes 34 on the two ends.

Then, the third estimation unit 27 estimates, concerning an off-edge position which is a third position not located on the edge 35 of the graph 33, a third congestion degree about the off-edge position from at least one of the first congestion degree, the second congestion degree, and the third congestion degree.

(Step S17 of FIG. 4: Output Process)

The output unit 25 generates data indicating a distribution of a congestion degree in the target space 50, from the first congestion degree estimated in step S13 and a congestion degree of another position estimated in step S15, 16. The output unit 25 outputs the data indicating the distribution of the congestion degree.

Specifically, the output unit 25 generates at least either one of data for display and numerical-value data for processing, as the data indicating the distribution of the congestion degree.

When generating the data for display, concerning each position in the target space 50, the output unit 25 generates image data which is colored according to a value of a congestion degree of that position. The output unit 25 superposes the generated image data to a plan view of the target space 50 to generate a heat map image. The output unit 25 outputs the heat map image to the display device as an output signal, or to an external device as an image file. Alternatively, the output unit 25 may output the image file to the storage 13.

When generating the numerical-value data, the output unit 25 describes numerical values expressing congestion degrees about positions in the target space 50, in a standard format. The output unit 25 outputs a numerical-value file describing the numerical values expressing the congestion degrees to the external device. Alternatively, the output unit 25 may output the numerical-value file to the storage 13.

Processing of step S12 through step S14 and processing of step S15 through step S17 may be executed asynchronously. That is, the processing of step S12 through step S14 is executed upon reception of the sensor data as a trigger. In the processing of step S12 through step S14, the first congestion degree is written in a buffer region in the memory 12 or storage 13. Processing of step S15 through step S16 is executed when an amount of data written in the buffer region exceeds a reference amount, or when the reference time has passed since last execution. In the processing of step S15 through step S16, the congestion degree about another position is estimated from the first congestion degree stored in the buffer region, and the data indicating the distribution of the congestion degree is outputted.

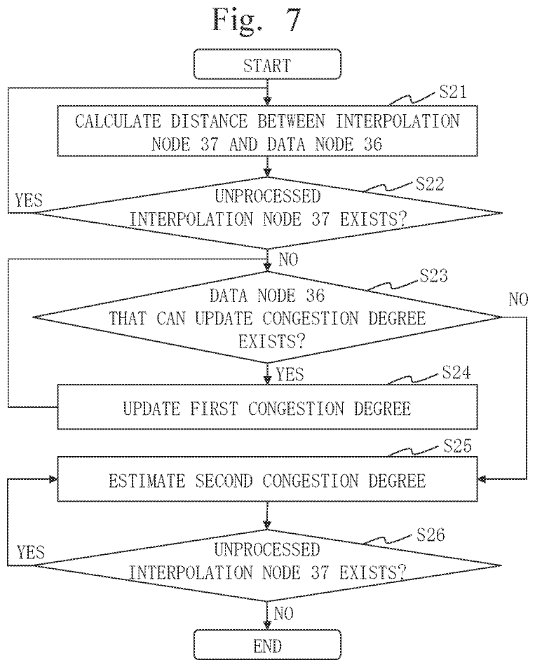

The second estimation process (step S15 of FIG. 4) according to Embodiment 1 will be described with referring to FIG. 7.

(Step S21 of FIG. 7: Distance Calculation Process)

The second estimation unit 26 focuses on, as a target, an interpolation node 37 that is not treated yet as a processing target, and calculates a distance between the target interpolation node 37 and each data node 36.

Specifically, the second estimation unit 26 identifies every data node 36 that can be reached from the target interpolation node 37 on the graph 33 via no other data node 36. The second estimation unit 26 focuses on each identified data node 36 as a target, and calculates a minimum distance on the graph 33 from the target interpolation node interpolation node 37 to the target data node 36.

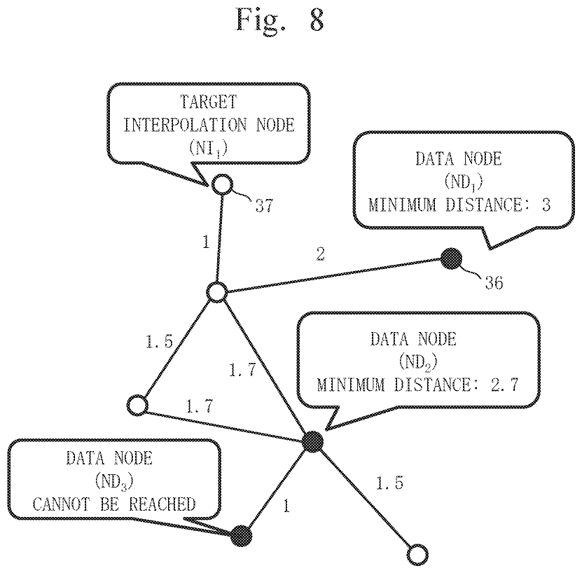

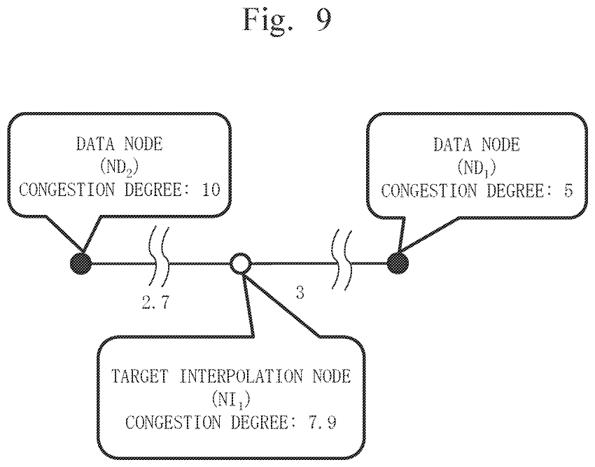

This will be specifically described with referring to FIGS. 8 and 9.

Assume that the target interpolation node 37 is NI₁. In this case, as illustrated in FIG. 8, ND₁ and ND₂ among the data nodes 36 can be reached from NI₁ via no other data node 36. However, ND₃ cannot be reached from NI₁ unless via ND₂. Therefore, in FIG. 8, with respect to NI₁, ND₁ and ND₂ are identified as the data nodes 36 that can be reached via no other data node 36. Then, a minimum distance from NI₁ to ND₁ and a minimum distance from NI₁ to ND₂ are calculated. As illustrated in FIG. 9, the minimum distance from NI₁ to ND₁ is calculated as 3, and the minimum distance from NI₁ to ND₂ is calculated as 2.7.

In processing to be described later, when estimating the second congestion degree about the second position expressed by the interpolation node 37, interpolation is performed from the first congestion degree of the first position expressed by the data node 36. A distance is not calculated about a data node 36 that cannot be reached unless via another data node 36 because, when calculating the second congestion degree about the second position expressed by the interpolation node 37, the first congestion degree about the first position expressed by that data node 36 is not taken into account.

This is because even if the first congestion degree about the first position expressed by the data node 36 that cannot be reached unless via another data node 36 is not taken into account, it suffices as far as the first congestion degree about the first position expressed by another data node 36 is taken into account. For example, in FIG. 8, when seen from NI₁, ND₃ is located across ND₂. Hence, it is supposed that a traveling object flowing from ND₃ into NI₁ is reflected in the congestion degree about the first position expressed by ND₂. Therefore, even if the congestion degree about the first position expressed by ND₃ is not taken into account, it may suffice as far as the congestion degree about the first position expressed by ND₂ is taken into account.

(Step S22 of FIG. 7: Process-Undone Judging Process)

The second estimation unit 26 judges whether or not there exists an interpolation node 37 not treated as a processing target of step S21.

If there exists an interpolation node 37 not treated as a target, the second estimation unit 26 returns to the process of step S21. On the other hand, if there exists no interpolation node 37 not treated as a target, the second estimation unit 26 proceeds to a process of step S23.

Processes of step S21 and step S22 may be executed in advance and stored to be included in the space structure information 31, instead of being executed in the distribution estimation process (step S15 of FIG. 4).

(Step S23 of FIG. 7: Update Judging Process)

The second estimation unit 26 judges whether or not there exits a data node 36 that can update the first congestion degree. In other words, the second estimation unit 26 judges whether or not there exists a data node 36 that expresses the first position about which the first congestion degree outputted in the first estimation process (step S13 of FIG. 4) has not yet been set.

If there exists a data node 36 that can update the first congestion degree, the second estimation unit 26 proceeds to a process of step S24. On the other hand, if there exists no data node 36 that can update the first congestion degree, the second estimation unit 26 proceeds to a process of step S25.

(Step S24 of FIG. 7: Congestion Degree Update Process)

The second estimation unit 26 updates the first congestion degree of the first position expressed by the data node 36 that can update the first congestion degree, with the first congestion degree outputted in the first estimation process (step S13 of FIG. 4).

In principle, execution of the distribution estimation process (step S15 of FIG. 4) rests on a premise that the first congestion degrees about the first positions expressed by all data nodes 36 have been outputted in the first estimation process (step S13 of FIG. 4). However, the first estimation process (step S13 of FIG. 4) is executed upon reception of the sensor data as a trigger. Therefore, when the distribution estimation process (step S15 of FIG. 4) is executed, there may be a case where sensor data has not been received from some sensors 42. In this case, the first congestion degrees of the first positions expressed by those some data nodes 36 have not been outputted in the first estimation process (step S13 of FIG. 4).

In this manner, if the first congestion degrees about the first positions expressed by some data nodes 36 have not been outputted in the first estimation process (step S13 of FIG. 4), the second estimation unit 26 updates the first congestion degree only about first positions for which the first congestion degrees have been outputted. Regarding the remaining first positions, the second estimation unit 26 uses the past first congestion degrees unchanged, or uses first congestion degrees obtained by correcting the past first congestion degrees by some method.

The second estimation unit 26 may treat the data nodes 36 expressing the remaining first positions, as interpolation nodes 37 temporarily. In this case, the second estimation unit 26 changes the data nodes 36 expressing the remaining first positions to the interpolation nodes 37, and then returns to the process of step S21 to do the process again.

(Step S25 of FIG. 7: Second Congestion Degree Estimation Process)

The second estimation unit 26 focuses on, as a target, an interpolation node 37 that is not treated yet as a processing target, and estimates the second congestion degree of the second position expressed by the target interpolation node 37.

Specifically, the second estimation unit 26 sets, as the target data node 36, every data node 36 that can be reached from the target interpolation node 37 via no other data node 36. The second estimation unit 26 estimates the second congestion degree about the second position expressed by the target interpolation node 37, from the minimum distance calculated in step S21 from the target interpolation node 37 to the target data node 36 on the graph 33, and from the first congestion degree about the first position expressed by the target data node 36.

In this estimation, the second estimation unit 26 calculates a first weight from the minimum distance from the target interpolation node 37 to the target data node 36. It is supposed that a data node 36 closer to the target interpolation node 37 would indicate a congestion degree closer to that of the target interpolation node 37. Therefore, the first weight is calculated such that the closer the minimum distance, the larger the weight. The second estimation unit 26 estimates the second congestion degree about the second position expressed by the target interpolation node 37, from a value obtained by multiplying, by the first weight, the first congestion degree about the first position expressed by the target data node 36. For example, the second estimation unit 26 uses a sum of values obtained about the target data nodes 36, as the second congestion degree. That is, the second estimation unit 26 calculates the second congestion degree by a calculation scheme called inverse distance weighting which uses the minimum distance from the target interpolation node 37 to the target data node 36.

Alternatively, the second estimation unit 26 may calculate the second congestion degree with using Formula 1 in which an expression of linear interpolation between two points is expanded.

$$s ( {NI}_{1} ) {\sum }_{c = 1}^{C} w ( c ) s ( {ND}_{c} ) \qquad [ Formula 1 ]$$

In Formula 1, s(NI₁) is a congestion degree about the second position expressed by NI₁ which is the target interpolation node 37. Also, s(ND_{c}) is a first congestion degree about the first position expressed by the data node 36 that can be reached from the target interpolation node 37 via no other data node 36. Note that 1≤c≤C where C is a number of data nodes 36 that can be reached from the target interpolation node 37 via no other data node 36. Also, w(c) is a second weight allotted to ND_{c} where w(c) is calculated by Formula 2.

$$w ( c ) = \frac{α ( c )}{{\sum }_{k = 1}^{C} α ( k )} \qquad [ Formula 2 ]$$

In Formula 2, α(c) and α(k) can be calculated by Formula 3.

$$α ( c ) {\prod }_{k = 1}^{C ( fk = c )} d ( k ) \qquad [ Formula 3 ]$$

Formula 3 signifies defining a product of d(k) for k of k=1 to k=C excluding k=c, as α(c). In Formula 3, d(k) is a minimum distance between NI₁ which is the target interpolation node 37 and NDₖ which is the target data node 36.

In the above description, the first congestion degree estimated by the process of step S13 that is executed immediately beforehand is used as s(ND_{c}). However, the congestion degree estimation process illustrated in FIG. 4 is a process that is executed repeatedly, as illustrated in FIG. 3. Hence, it is possible to use, as s(ND_{c}), a first congestion degree estimated at the time the congestion degree estimation process was executed in the past.

In that case, to use a first congestion degree that is past by how long can be decided arbitrarily. In a specific example, a first congestion degree that is past by a fixed time period may be used. A first congestion degree that is past by a value proportional to d(k), which is a minimum distance between NI₁ being the target interpolation node 37 and NDₖ being the target data node 36, may be used. If a traveling direction or traveling speed of a crowd within the sensor range can be estimated by some method using sensor data of a sensor 42 corresponding to the data node, a past first congestion degree to be used may be decided adaptably with using those information.

(Step S26 of FIG. 7: Process-Undone Judging Process)

The second estimation unit 26 judges whether or not there exists an interpolation node 37 not treated as a processing target of step S25.

If there exists an interpolation node 37 not treated as a processing target, the second estimation unit 26 returns to the process of step S25. On the other hand, if there exists no interpolation node 37 not treated as a processing target, the second estimation unit 26 proceeds to a process of step S27.

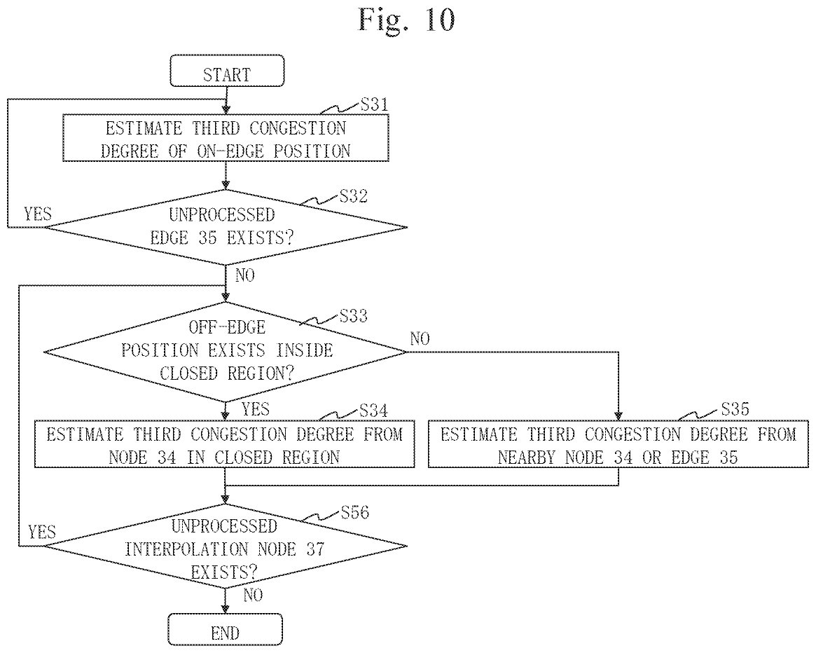

The third estimation process (step S16 of FIG. 4) according to Embodiment 1 will be described with referring to FIG. 10.

(Step S31: On-Edge Estimation Process)

The third estimation unit 27 focuses on, as a target, an edge 35 that is not treated yet as a processing target, and estimates the third congestion degree about an on-edge position which is a third position located on the target edge 35.

Specifically, the third estimation unit 27 sequentially sets positions on the target edge 35 as the target on-edge position. The third estimation unit 27 estimates the third congestion degree about the target on-edge position from the congestion degrees about positions expressed by the nodes 34 on the two ends of the target edge 35, by an interpolation scheme such as linear interpolation. The nodes 34 on the two ends may be data nodes 36, or may be interpolation nodes 37.

In Embodiment 1, first, the third estimation unit 27 calculates distances from the nodes 34 on the two ends of the target edge 35 to the target on-edge position. The third estimation unit 27 calculates second weights for the nodes 34 on the two ends, from the distances. It is supposed that a node 34 closer to the target on-edge position would indicate a congestion degree closer to that of the target on-edge position. Therefore, the second weight is calculated such that the closer the distance, the larger the weight. The third estimation unit 27 estimates the third congestion degree about the third position expressed by the target on-edge position, from values obtained by multiplying, by the second weights, the congestion degrees about positions expressed by the nodes 34 on the two ends. For example, the third estimation unit 27 uses a sum of the values obtained about the nodes 34 on the two ends, as the third congestion degree. The nodes 34 on the two ends may be data nodes 36, or may be interpolation nodes 37. Hence, the positions expressed by the nodes 34 on the two ends may be first positions, or may be second positions. Accordingly, the congestion degrees of the positions expressed by the nodes 34 on the two ends may be first congestion degrees, or may be second congestion degrees.

For example, note that a node 34 on one end of an edge E having a length L_{E} is defined as Nₛ, and a node 34 on the other end of the edge E is defined as N_{c}. Assume that a distance from Nₛ to N_{L} which is an on-edge position on the edge E is 1 (0≤1≤L_{E}). In this case, the third congestion degree of N_{L} is calculated by Formula 4.

$$s ( {N}_{i} ) = \frac{( {L}_{E} - l ) * s ( {N}_{s} ) + l * s ( {N}_{e} )}{{L}_{E}} \qquad [ Formula 4 ]$$

In Formula 4, s(Nₛ) is a congestion degree of Nₛ, and s(N_{c}) is a congestion degree of Ne.

(Step S32: Process-Undone Judging Process)

The third estimation unit 27 judges whether there exists an edge 35 not treated as a processing target of step S31.

If there exists an edge 35 not treated as a target, the third estimation unit 27 returns to the process of step S31. On the other hand, if there exists no edge 35 not treated as a target, the third estimation unit 27 proceeds to a process of step S33.

From step S33 through step S35, the third estimation unit 27 estimates the third congestion degree about an off-edge position that is a third position not located on an edge 35 of the graph 33. The third congestion degree about the off-edge position is estimated by either one of two methods depending on a position in the target space 50 of the off-edge position. Hence, first, the third estimation unit 27 sorts the case according to a position in the target space 50 of the target off-edge position.

(Step S33: Position Judging Process)

The third estimation unit 27 focuses on, as a target, an off-edge position not treated yet as a processing target, and judges whether or not a target off-edge position exists inside the closed region enclosed by edges 35 in the graph 33.

If a target off-edge position exists inside the closed region, the third estimation unit 27 proceeds to a process of step S34. On the other hand, if a target off-edge position does not exist inside the closed region, the third estimation unit 27 proceeds to a process of step S35.

If there exists an off-edge position inside the closed region, it signifies that the off-edge position exists in a place like an open space where a distinct traveling direction is not defined. For this reason, the third estimation unit 27 estimates the third congestion degree with using an all-direction-uniform interpolation scheme that uses a congestion degree about a nearby position.

If an off-edge position does not exist inside the closed region, it signifies that the off-edge position exists outside a place like a passage where a traveling direction is limited to a direction along the edge, or outside a space structure defined by the graph 33. Outside the space structure defined by the graph 33 is an outer periphery of a place like an open space. Therefore, the third estimation unit 27 estimates the third congestion degree with using an interpolation scheme that uses a congestion degree about a nearest position.

As has been described with referring to FIGS. 5 and 6, there is a case where a connecting relationship not expressed by the mask image 32 or the graph 33 exceptionally is involved in the target space 50.

In this case, the third estimation unit 27 must judge whether or not a region outside the target space 50 is involved inside the closed region in which an off-edge position exists, in addition to whether or not there exists an off-edge position inside the closed region. To judge whether a region outside the target space 50 is involved inside the closed region signifies to judge whether or not, when the graph 33 is lapped on the mask image 32, a region expressed by black of the mask image 32 is involved in the closed region.

If an off-edge position exists inside the closed region and if a region outside the target space 50 is not involved inside the closed region, the third estimation unit 27 proceeds to a process of step S34. On the other hand, at least, if an off-edge position does not exist inside the closed region, or if a region outside the target space 50 is involved inside the closed region, the third estimation unit 27 proceeds to a process of step S35.

(Step S34: Inside-Closed-Region Estimation Process)

The third estimation unit 27 estimates the third congestion degree about the target off-edge position from a congestion degree of a position expressed by a node 34 constituting a closed region enclosing the target off-edge position. The node 34 constituting the closed region may be a data node 36, or may be an interpolation node 37. The position expressed by the node 34 may be a first position, or may be a second position. The congestion degree of the position expressed by the node 34 may be a first congestion degree, or may be a second congestion degree.

In a specific example, the third estimation unit 27 estimates the third congestion degree with using the congestion degree of the position expressed by the node 34 constituting the closed region, in accordance with an interpolation scheme such as a scheme called a triangular interpolation scheme which performs interpolation inside a triangular element, and a scheme called an inverse distance weighting which uses a Euclidean distance.

If the closed region is triangular, the scheme of performing interpolation inside a triangular element is applicable as at is. However, if the closed region is not triangular, the closed region is divided into a plurality of triangular regions. Then, using the congestion degree of the position expressed by the node 34 constituting the triangular region that involves the off-edge position, the scheme of performing interpolation inside a triangular element may be applied.

(Step S35: Outside-Closed-Region Estimation Process)

The third estimation unit 27 estimates the third congestion degree about the target off-edge position from a congestion degree of a position expressed by a node 34 or of an on-edge position, each of which exists in the same region as the target off-edge position and is the closest to the target off-edge position. This region signifies a region expressed in white in the mask image 32. For example, the region X and the region Y in FIG. 2 are different regions.

In a specific example, the third estimation unit 27 estimates the congestion degree as it is, of the node 34 or on-edge position existing in the same region as the target off-edge position and is the closest to the target off-edge position, as the third congestion degree. Alternatively, the interpolation node 37 may estimate the third congestion degree by multiplying the congestion degree of the node 34 or on-edge position each being the closest, by a weight inversely proportional to a distance from the off-edge position.

The on-edge position the closest to the target off-edge position is identified as follows. First, perpendiculars are drawn from the target off-edge position to peripheral edges 35. A perpendicular whose length between the off-edge position and an intersection of the perpendicular and the edge 35 is the shortest, is identified. An on-edge position on the edge 35 the closest to the identified perpendicular is identified as the on-edge position the closest to the off-edge position.

By adding a condition of existing in the same region as the off-edge position, a node 34 and an edge 35 to be used for interpolation are limited to those existing in the same region. As a result, a congestion degree is not estimated on the basis of congestion degrees of a node 34 and an edge 35 that are not spatially connected to each other.

(Step S36: Process-Undone Judging Process)

The third estimation unit 27 judges whether or not there exists an off-edge position not treated as a processing target of step S33.

If there exists an off-edge position not treated as a target, the third estimation unit 27 returns to the process step S33. On the other hand, if there exists no off-edge position not treated as a target, the third estimation unit 27 ends the processing.

***Effect of Embodiment 1***

As has been described above, the congestion degree estimation device 10 according to Embodiment 1 estimates the second congestion degree about the second position on the travel route of the traveling object, from the first congestion degree estimated on the basis of the sensor data. Then, the congestion degree estimation device 10 estimates the third congestion degree about another position, from the first congestion degree and the second congestion degree.

As a result, it is possible to estimate a congestion degree appropriately on the basis of an assumed travel of the traveling object in the target space.

***Other Configurations***

<Modification 1>

In the congestion degree estimation device 10 according to Embodiment 1, the second congestion degree is estimated from the first congestion degree estimated on the basis of the sensor data which is acquired by the sensor data acquisition unit 22 from the sensor 42 in the series of processes illustrated in FIG. 4. However, if the series of processes illustrated in FIG. 4 is performed repeatedly at a predetermined time cycle, the second congestion degree may be estimated from a first congestion degree that is based on sensor data acquired in past processing execution.

<Modification 2>

In Embodiment 1, the function constituent elements are implemented by software. In Modification 2, the function constituent elements may be implemented by hardware. This Modification 2 will be described regarding its difference from Embodiment 1.

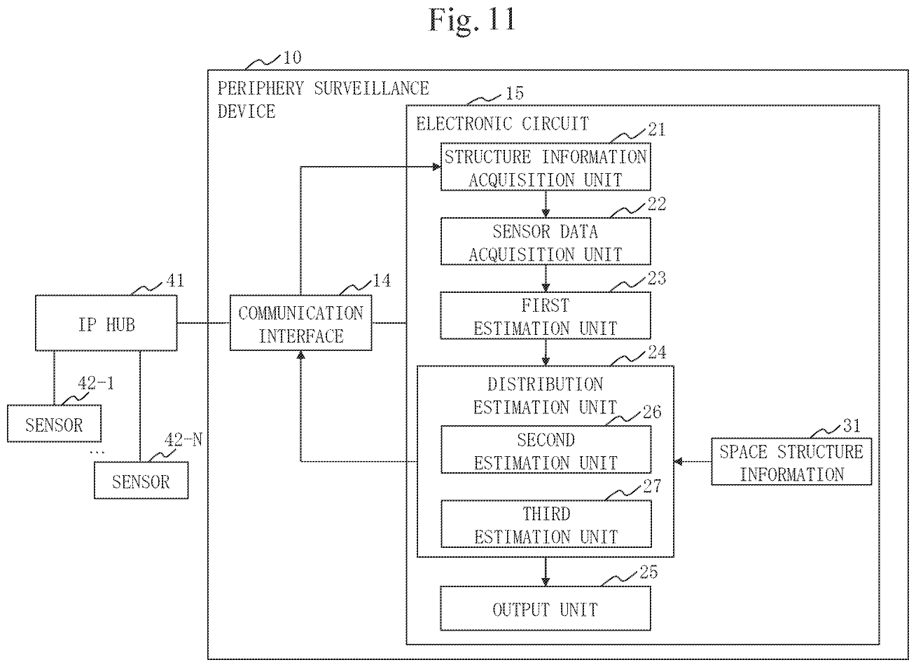

A configuration of a congestion degree estimation device 10 according to Modification 2 will be described with referring to FIG. 11.

If the function constituent elements are implemented by hardware, the congestion degree estimation device 10 is provided with an electronic circuit 15 in place of a processor 11, a memory 12, and a storage 13. The electronic circuit 15 is a dedicated circuit that implements the functions of the function constituent elements and the functions of the memory 12 and storage 13.

It is supposed that the electronic circuit 15 may be a single circuit, a composite circuit, a programmed processor, a parallel-programmed processor, a logic IC, a Gate Array (GA), an Application Specific Integrated Circuit (ASIC), or a Field-Programmable Gate Array (FPGA).

The function constituent elements may be implemented by one electronic circuit 15, or by a plurality of electronic circuits 15 through dispersion.

<Modification 3>

In Modification 3, some of the function constituent elements may be implemented by hardware, and the remaining function constituent elements may be implemented by software.

The processor 11, the memory 12, the storage 13, and the electronic circuit 15 are referred to as processing circuitry. That is, the functions of the function constituent elements are implemented by processing circuitry.

So far, an embodiment and modifications of the present invention have been described. Some of the embodiment and modifications may be practiced in combination. One or some of the embodiment and modifications may be practiced partly. Note that the present invention is not limited to the above embodiment and modifications, but various changes can be made to the present invention as necessary.

### REFERENCE SIGNS LIST

10: congestion degree estimation device; 11: processor; 12: memory; 13: storage; 14: communication interface; 15: electronic circuit; 21: structure information acquisition unit; 22: sensor data acquisition unit; 23: first estimation unit; 24: distribution estimation unit; 25: output unit; 26: second estimation unit; 27: third estimation unit; 31: space structure information; 32: mask image; 33: graph; 34: node; 35: edge; 36: data node; 37: interpolation node; 41: IP hub; 42: sensor; 50: target space; 51: measurement point.

1. A congestion degree estimation device comprising:
processing circuitry
to estimate, on a basis of sensor data acquired from a sensor allocated to a first position in a target space, a first congestion degree being a congestion degree about the first position;
to estimate a second congestion degree being a congestion degree about a second position, on a basis of the estimated first congestion degree, the second position being a position on a travel route of a traveling object in the target space and being different from the first position;
to estimate a third congestion degree being a congestion degree about a third position which is neither the first position nor the second position in the target space, on a basis of the first congestion degree and the estimated second congestion degree; and
to acquire a graph formed by connecting, with an edge, nodes between which the traveling object can travel, the nodes being the first position and the second position, the node that expresses the first position serving as a data node, the node that expresses the second position serving as an interpolation node,
wherein the processing circuitry
focuses on, as a target, each data node that can be reached from the interpolation node on the graph via no other data node, and estimates the second congestion degree about the second position expressed by the interpolation node, from a distance from the interpolation node to the target data node, and from the first congestion degree about the first position expressed by the target data node, and
focuses on each edge of the graph as a target and, concerning an on-edge position which is the third position located on the target edge, estimates the third congestion degree about the on-edge position, from distances from the nodes on two ends of the target edge to the on-edge position, and from congestion degrees about positions expressed by the nodes on the two ends.

2. The congestion degree estimation device according to claim 1,
wherein the processing circuitry calculates a first weight from a distance from the interpolation node to the target data node, and estimates the second congestion degree about the second position expressed by the interpolation node, from a value obtained by multiplying, by the first weight, the first congestion degree about the first position expressed by the target data node.

3. The congestion degree estimation device according to claim 1,
wherein the processing circuitry focuses on the nodes on the two ends, as targets, takes distances from the target nodes to the on-edge position, as second weights, and estimates the third congestion degree about the on-edge position from values obtained by multiplying, by the second weights, congestion degrees about positions expressed by the target nodes.

4. The congestion degree estimation device according to claim 1,
wherein the processing circuitry estimates, concerning an off-edge position which is the third position not located on the edge of the graph, the third congestion degree about the off-edge position from at least one of the first congestion degree, the second congestion degree, and the third congestion degree about the on-edge position.

5. The congestion degree estimation device according to claim 4,
wherein the processing circuitry, if the off-edge position exists inside a closed region enclosed by the edges in the graph, estimates the third congestion degree about the off-edge position from a congestion degree of a position expressed by a node that constitutes the closed region enclosing the off-edge position.

6. The congestion degree estimation device according to claim 4,
wherein the processing circuitry, if the off-edge position exists outside a closed region enclosed by the edges on the graph, estimates the third congestion degree about the off-edge position from a congestion degree about a position expressed by a node or an edge each of which is the closest from the off-edge position.

7. A congestion degree estimation method comprising:
estimating, on a basis of sensor data acquired from a sensor allocated to a position in a target space, a first congestion degree being a congestion degree about the first position;
estimating a second congestion degree being a congestion degree about a second position, on a basis of the first congestion degree, the second position being a position on a travel route of a traveling object in the target space and being different from the first position;
estimating a third congestion degree being a congestion degree about a third position which is neither the first position nor the second position in the target space, on a basis of the first congestion degree and the second congestion degree;
acquiring a graph formed by connecting, with an edge, nodes between which the traveling object can travel, the nodes being the first position and the second position, the node that expresses the first position serving as a data node, the node that expresses the second position serving as an interpolation node;
focusing on, as a target, each data node that can be reached from the interpolation node on the graph via no other data node, and estimating the second congestion degree about the second position expressed by the interpolation node, from a distance from the interpolation node to the target data node, and from the first congestion degree about the first position expressed by the target data node; and
focusing on each edge of the graph as a target and, concerning an on-edge position which is the third position located on the target edge, estimating the third congestion degree about the on-edge position, from distances from the nodes on two ends of the target edge to the on-edge position, and from congestion degrees about positions expressed by the nodes on the two ends.

8. A non-transitory computer-readable recording medium recorded with a congestion degree estimation program which causes a computer to function as a congestion degree estimation device that performs:
a first estimation process of estimating, on a basis of sensor data acquired from a sensor allocated to a first position in a target space, a first congestion degree being a congestion degree about the first position;
a second estimation process of estimating a second congestion degree being a congestion degree about a second position, on a basis of the first congestion degree estimated by the first estimation process, the second position being a position on a travel route of a traveling object in the target space and being different from the first position;
a third estimation process of estimating a third congestion degree being a congestion degree about a third position which is neither the first position nor the second position in the target space, on a basis of the first congestion degree and the second congestion degree which is estimated by the second estimation process; and
a structure information acquisition process of acquiring a graph formed by connecting, with an edge, nodes between which the traveling object can travel, the nodes being the first position and the second position, the node that expresses the first position serving as a data node, the node that expresses the second position serving as an interpolation node,
wherein the second estimation process includes focusing on, as a target, each data node that can be reached from the interpolation node on the graph via no other data node, and estimating the second congestion degree about the second position expressed by the interpolation node, from a distance from the interpolation node to the target data node, and from the first congestion degree about the first position expressed by the target data node, and
wherein the third estimation process includes focusing on each edge of the graph as a target and, concerning an on-edge position which is the third position located on the target edge, estimating the third congestion degree about the on-edge position, from distances from the nodes on two ends of the target edge to the on-edge position, and from congestion degrees about positions expressed by the nodes on the two ends.
